(19) United States
(12) Patent Application Publication
(10) Pub. No.: US 2012/0238215 A1
(43) Pub. Date: Sep. 20, 2012

(54) Apparatus and Method for a Headset Device

(75) Inventors: Juhani V. Kari, Lieto (FI); Heini Saari, Turku (FI); Petri J. Seppala, Halikko (FI); Olga Cherepenina, Salo (FI)

(73) Assignee: Nokia Corporation

(21) Appl. No.: 13/048,083

(22) Filed: Mar. 15, 2011

(51) Int. Cl. H04B 7/00

(52) U.S. Cl. 455/41.3

(57) ABSTRACT

In accordance with an example embodiment of the present invention, an apparatus is disclosed. The apparatus includes an earpiece member and a main body member. The main body member includes a receiving area. The main body member is configured to provide a communication link with a mobile device. The receiving area is configured to removably receive the earpiece member. The apparatus is configured to perform a predetermined operation in response to removal of the earpiece member from the receiving area.

### TECHNICAL FIELD

The invention relates to headset device and, more particularly, to a wireless headset device.

### BACKGROUND

Wireless headsets are a class of accessory devices widely used with various portable electronic devices. Wireless headsets enable the user to access audio features of a portable device while the device itself may be stowed away and located at a distance from the user. Example applications of wireless headsets include having a telephone conversation while being engaged in another activity such as driving a car, or listening to music while the device is stowed in a bag or a pocket.

Wireless headset units may comprise audio transducers for capturing and reproducing sound waves, and they are configured for communication with other devices by various methods, such as short-range radio techniques, for example. Various headset devices such as Bluetooth headsets are popular accessory products that are designed to improve usability of mobile phones. Wireless headset units may also comprise input devices for controlling various features the unit, such as one or more buttons for switching the unit on or off, and receiving or ending a call. The units may be monaural or stereophonic, and they may be designed to be worn by the user on the ear, over the head, or in other suitable ways. As consumers demand increased functionality from electronic devices, there is a need to provide improved headset units which allow for an improved user experience by providing for ease of use when performing device actions/operations such as powering on, connecting to a paired device, and accepting a call.

### SUMMARY

Various aspects of examples of the invention are set out in the claims.

According to a first aspect of the present invention, an apparatus is disclosed. The apparatus includes an earpiece member and a main body member. The main body member includes a receiving area. The main body member is configured to provide a communication link with a mobile device. The receiving area is configured to removably receive the earpiece member. The apparatus is configured to perform a predetermined operation in response to removal of the earpiece member from the receiving area.

According to a second aspect of the present invention, a method is disclosed. Removal of an earpiece member of a wireless headset device from a main body member of the wireless headset device is detected. A predetermined operation is performed in response to the detected removal of the earpiece member of the wireless headset device from the main body member of the wireless headset device.

According to a third aspect of the present invention, an apparatus is disclosed. The apparatus includes an earpiece member, a main body member, at least one processor, and at least one memory. The main body member includes a receiving area. The main body member is configured to provide a communication link with a mobile device. The receiving area is configured to removably receive the earpiece member. The at least one memory includes computer program code. The at least one memory and the computer program code are configured to, with the at least one processor, cause the apparatus to perform at least the following: detect a movement of the earpiece member at the receiving area. Perform a predetermined operation in response to the detected movement of the earpiece member at the receiving area.

### BRIEF DESCRIPTION OF THE DRAWINGS

For a more complete understanding of example embodiments of the present invention, reference is now made to the following descriptions taken in connection with the accompanying drawings in which:

FIG. 1 is a perspective view of a headset device (in a transport position) incorporating features of the invention;

FIG. 2 is a perspective view of a user and the device shown in FIG. 1;

FIG. 3 is a schematic drawing illustrating components of the device shown in FIG. 1;

FIG. 4 is a block diagram of an exemplary method incorporating features of the invention;

FIG. 5 is a block diagram of another exemplary method incorporating features of the invention;

FIG. 6 is a block diagram of another exemplary method incorporating features of the invention;

FIG. 7 is a block diagram of another exemplary method incorporating features of the invention;

FIG. 8 is a block diagram of another exemplary method incorporating features of the invention;

FIG. 9 is a block diagram of another exemplary method incorporating features of the invention;

FIGS. 10-14 are views of another example embodiment of a headset device incorporating features of the invention; and

FIGS. 15-17 are views of another example embodiment of a headset device incorporating features of the invention.

### DETAILED DESCRIPTION OF THE DRAWINGS

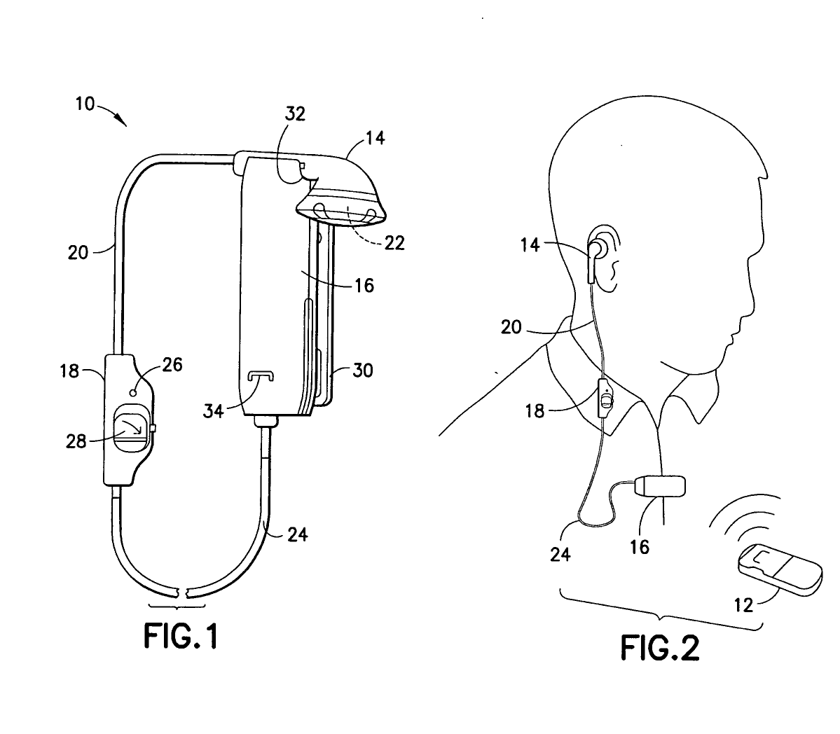

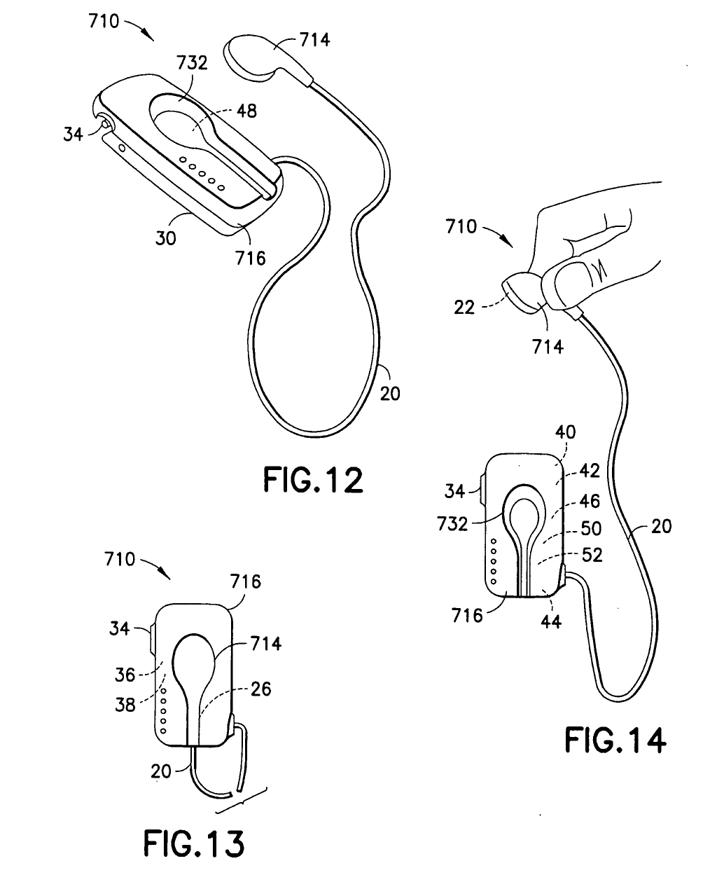

An example embodiment of the present invention and its potential advantages are understood by referring to FIGS. 1 through 17 of the drawings.

Referring to FIG. 1, there is shown a perspective view of a wireless headset device 10 incorporating features of the invention. Although the invention will be described with reference to the exemplary embodiments shown in the drawings, it should be understood that the invention can be embodied in many alternate forms of embodiments. In addition, any suitable size, shape or type of elements or materials could be used.

According to one example of the invention, the wireless headset device 10 is communication device that communicates wirelessly with a base device 12 and may be worn proximate to a head of a user of the wireless headset device 10 (as shown in FIG. 2). However, in alternate embodiments, features of the various embodiments of the invention could be used in any suitable type of portable electronic device.

Communication comprises audio signals, which may represent speech, music, or other types of audio transmissions. The wireless headset (or wireless headset device) 10 comprises an earpiece member 14, a main body member 16, and an input control member 18. The earpiece member 14 is connected to the input control member 18 by a wire 20. The earpiece member 14 comprises a loudspeaker element 22. The input control member 18 is connected to the main body member 16 by a wire 24. The input control member 18 comprises a microphone 26 and a mute switch 28. However, in an alternate embodiment, the earpiece member 14, the main body member 16, and the input control member 18 are connected by a wireless connection. Additionally, any suitable number of members or combination of wired/wireless connections may be provided.

The main body member 16 comprises a clip 30 and a receiving area 32. The clip 30 extends from a rear side of the main body member 16 in a general cantilever fashion. The clip 30 is suitably sized and shaped for attachment purposes. For example, the clip 30 allows for the main body member 16 to be clipped on to an article of clothing as shown in FIG. 2. However, the clip 30 may be attachable to any suitable object. Additionally, the main body member 16 may be placed in any suitable location, such as a pocket or a holder for example. The receiving area 32 comprises a general groove shape suitably sized to receive a portion of the earpiece member 14. The receiving area 32 may be configured to securely hold the earpiece member 14 when received in the receiving area 32 such as by a press fit between the earpiece member 14 and the groove 32, for example. However, any suitable configuration for the earpiece member and the receiving area interface may be provided.

The wireless headset 10 is generally configured to be worn by the user in such a way that an audio signal provided by the loudspeaker element 22 is audible for the user, and the microphone 26 captures the voice of the user. In an embodiment, the earpiece member 14 is suitably sized and shaped to be received in the ear of the user with the loudspeaker element 22 disposed in the earpiece member 14 and suitably positioned with respect to the ear. The input control member 18 is suitably positioned between the earpiece member 14 and the main body member 16 such that the microphone 26 may be proximate to the mouth of the user when the wireless headset 10 is being worn by the user.

In an embodiment, the wireless headset 10 comprises a switch 34, which is configured to actuate, for example, power on/off state, accepting or terminating call, and/or other functions relating to the wireless headset 10. However, in some embodiments of the invention, the switch 34 is not present. In some embodiments, a plurality of switches and/or other input devices may be provided. In some embodiments, the switch may be configured to be responsive to a long key press, which means that a predetermined delay time is allowed to lapse before an actuation signal is produced. It should be understood that many variations of mechanical design are possible without departure from the spirit of the invention. For example, the wireless headset 10 may be provided with various removable or extendable elements for improving ergonomics, such as an ear loop part for supporting the earpiece member in its use position. Additionally, while a monaural wireless headset 10 is illustrated in the drawings, a stereophonic headset may be provided without departing from the spirit of the invention.

According to some embodiments of the invention, the wireless headset further comprises an indicator light at the receiving area (or storage slot) 32. However, in some embodiments an indicator light may be provided at any suitable location, such as on the earpiece member, for example.

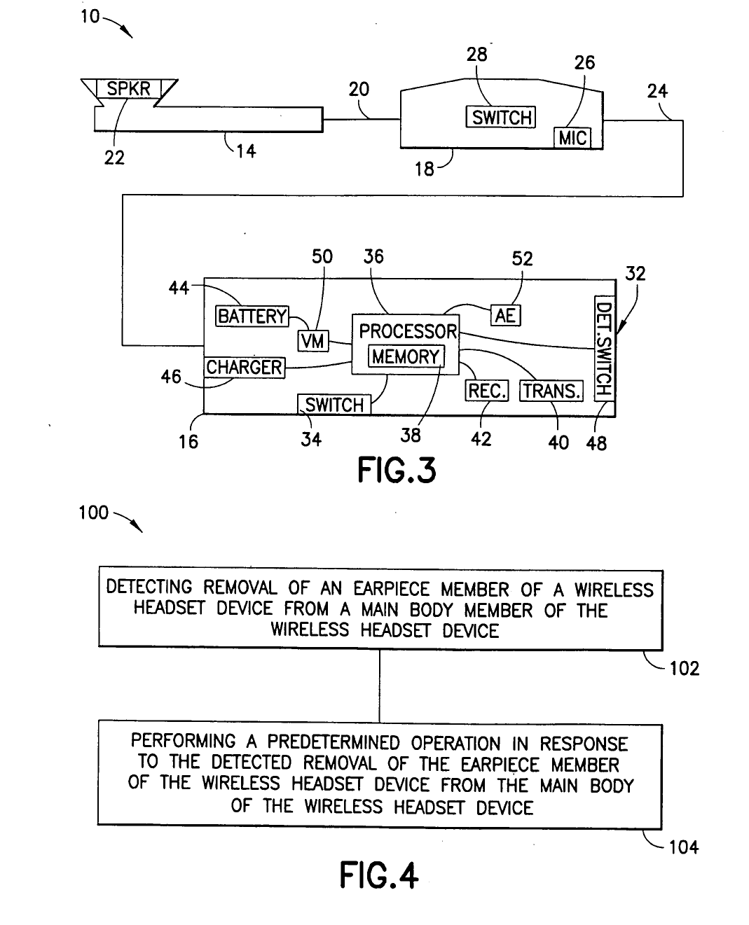

Referring now also to FIG. 3, there is shown a block diagram illustrating various components and/or electronic circuitry of the wireless headset 10. In an embodiment, the wireless headset 10 comprises at least one processor 36 and at least one memory 38 including computer program code. The at least one memory 38 and the computer program code are configured to, with the at least one processor 36, cause the apparatus (wireless headset unit) 10 to perform methods comprising embodiments of the invention. The at least one processor 36 may be operatively coupled to the loudspeaker element 22 and the microphone 26 through wires 20, 24. In some embodiments, the at least one processor 36 may be coupled to the switch 34, which is configured to actuate, for example, power on/off state, accepting or terminating call, and/or other functions relating to the wireless headset 10. However, in some embodiments of the invention the switch 34 is not present. The wireless headset 10 further comprises a transmitter 40 and a receiver 42, such as a Bluetooth transmitter and a Bluetooth receiver. The wireless headset 10 further comprises a power source, such as a battery 44. In an embodiment, the wireless headset 10 also comprises a charger or charging interface 46 for charging the battery 44. The headset 10 further comprises a detection switch 48 at the receiving area 32, which may be a mechanical, electrical, magnetic, or other type of switch. The detection switch 48 is configured to be actuated according to whether the wireless headset 10 is coupled or uncoupled with the earpiece member. It should further be noted that although the descriptions and figures provide for the detection switch to be located at, or proximate, the receiving area, alternate embodiments may provide any suitable location for the detection switch.

In an embodiment, the wireless headset 10 may be configured to monitor the remaining charge level of the battery 44 and to detect a first battery charge level and a second battery charge level. In an embodiment, the second battery charge level is lower than the first battery charge level. The first battery charge level may correspond to a low charge level, in which the remaining charge is only sufficient to power the wireless headset for a relatively short time. The second battery charge level may correspond to a substantially empty state, in which the remaining charge is no longer sufficient to maintain the wireless headset 10 in a powered state. For monitoring the battery charge level, the wireless headset 10 comprises in an embodiment a voltage monitoring element 50, which is connected with the battery 44 and the at least one processor 36 for monitoring the voltage of the battery 44.

In an embodiment, the wireless headset 10 comprises an alert element 52, which may be configured to provide alerts when the first battery charge level or the second battery charge level is detected. The alert element 52 may be configured to provide an audio alert, a haptic alert, a visual alert using a LED or a display, or any other suitable type of alert signal. However the loudspeaker element 22 may be used for providing alert signals. In an embodiment, the alert element 52 may not be present.

FIG. 1 shows the earpiece member 14 coupled with the main body member 16 at the receiving area 32. FIG. 2 shows the earpiece member 14 uncoupled from the main body member 16, and the mobile device 12. As shown, the earpiece 14 is in the ear of the user so that the loudspeaker element 22 is audible to the user, the main body member 16 is clipped on to the user's clothing, and the input control member 18 is proximate the user's mouth such that the microphone 26 can capture the voice of the user. The wireless headset 10 and the mobile device 12 may be configured to communicate wirelessly with each other (such as through a Bluetooth wireless connection, for example). While the mobile device 12 is illustrated as a mobile telephone, the mobile device 12 may be a portable computer, multimedia device, gaming device, navigation device, electronic document reading device, and/or any other electronic device with audio capabilities.

According to some embodiments of the invention, various headset unit device operations may be performed when a movement of the earpiece member 14 relative to the receiving area 32 is sensed or detected. This generally allows for a single action from the user to cause the headset unit device 10 to perform a device operation (such as a powering up operation, connecting to a device operation, and accepting a possible call, or other audio stream, operation, for example). These operations are triggered by removing the earpiece member 14 from main body member 16.

For example, in some embodiments of the invention, when the user of the headset unit device 10 removes the earpiece 14 from the storage slot (or receiving area) 32, the headset unit device 10 is configured to detect the removal of the earpiece member 14 from the receiving area 32 and the switch the headset 10 ‘ON’ (in response to the detected removal). The headset 10 may then beep, and a green indicator light may flash slowly while the headset 10 tries to connect to the last, or last two, connected devices. However, any suitable configuration for switching the headset ‘ON’ may be provided.

According to some embodiments of the invention, when the headset 10 is connected to at least one device and is ready for use, a blue indicator light flashes slowly. If the headset 10 has not been paired with a device, it automatically enters pairing mode.

Additional headset unit device operations may be performed when a movement of the earpiece relative to the receiving area is sensed or detected. For example, in various exemplary embodiments of the invention, the headset unit device is switched ‘OFF’ when the user places the earpiece 14 into the receiving area (or storage slot) 32. The headset 10 may then beep, and a red indicator light is briefly displayed. Additionally, in some embodiments if the headset 10 is not connected to a device within about thirty minutes, the headset unit device 10 switches off automatically.

According to some embodiments of the invention, to answer a call (such as an incoming call at the device 12), the user removes the earpiece 14 from the storage slot 32. When the user removes the earpiece member 14 from the storage slot (or receiving area) 32, the headset 10 automatically switches on, connects the headset unit device 10 to the device 12, and answers the incoming call. If the earpiece 14 is not in the storage slot when there is an incoming call, the user may press the answer/end key 34. Additionally, in some embodiments, to reject an incoming call, the user may press the answer/end key 34 twice, or place the earpiece 14 into the storage slot 32.

According to some embodiments of the invention, to end a call, the user can place the earpiece 14 into the storage slot 32. When the user places the earpiece member 14 into the storage slot (or receiving area) 32, the headset 10 automatically terminates the call, disconnects the headset unit device 10 from the device 12, and switches the headset unit device 10 ‘OFF’. Additionally, in some embodiments of the invention, the user may also press the answer/end key 34 to end the call when the earpiece 14 is not in the storage slot 32.

FIG. 4 illustrates a method 100. The method 100 includes detecting removal of an earpiece member of a wireless headset device from a main body member of the wireless headset device (at block 102). Performing a predetermined operation in response to the detected removal of the earpiece member of the wireless headset device from the main body member of the wireless headset device (at block 104).

The predetermined operation can include switching the wireless headset device 10 to a powered state, establishing a communication link with the mobile device (such as the mobile phone 12), and detecting a connection attempt and accepting the connection attempt when the removal is detected. Additionally, the wireless headset device 10 is further configured to detect a coupling of the earpiece member 14 with the receiving area 32 of the main body member 16 and perform at least one of terminating a connection, disconnecting a communication link (such as a link with the phone 12), and switching the wireless headset device 10 to an unpowered state when the coupling is detected. It should be noted that the illustration of a particular order of the blocks does not necessarily imply that there is a required or preferred order for the blocks and the order and arrangement of the blocks may be varied. Furthermore it may be possible for some blocks to be omitted.

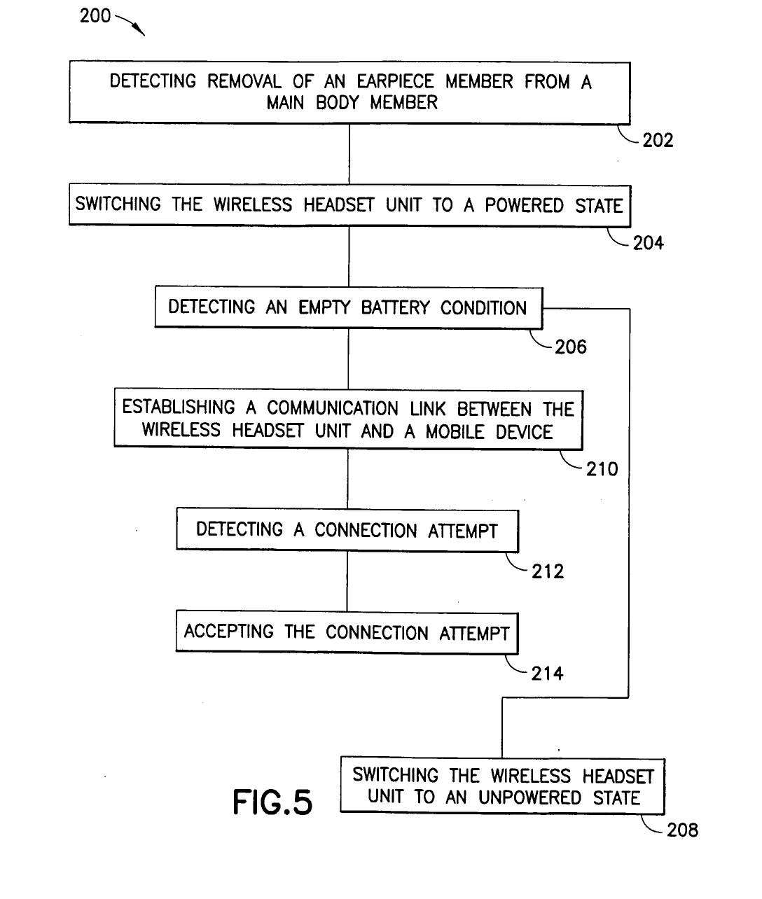

FIG. 5 is a flow diagram illustrating another method 200 according to an example embodiment of the invention. Consider the wireless headset unit device 10 of FIG. 1 in an unpowered state. In this state the receiver 42, the transmitter 40, the processor 36, and other elements of the wireless headset 10 may be in a non-operating state. In an embodiment, no communication link exists with other devices. In an embodiment, substantially no current is being drawn from the battery 44 of the headset device 10. The unpowered state may correspond to the state illustrated in FIG. 1, where the earpiece member 14 is coupled to the main body member 16 at the receiving area (or storage slot) 32. At 202, if the earpiece member 14 is removed from the receiving area 32, an actuation of the detection switch 48 occurs. At 204, the actuation causes the wireless headset 10 to switch to a powered state. In the powered state, the receiver 42, the transmitter 40, the processor 36, and other elements of the wireless headset 10 may be in an operating state, powered by the battery 44. At 206, the charge level of the battery 44 is checked, and if an empty battery condition is detected, the wireless communication headset 10 is switched to an unpowered state at 208. If an empty battery condition is not detected, establishing a communication link with another device is attempted at 210. In an embodiment, the communication link may be a Bluetooth connection. In an embodiment, the other device is the mobile device 12. After a communication link has been sufficiently established, a connection attempt from the mobile device 12 may be detected at 212, and if such connection call is detected, it is automatically accepted at 214. In an embodiment, the connection attempt is a phone call received by the mobile device 12. In this embodiment, accepting the connection attempt at 214 results in the wireless headset 10 being in an active call state, in which audio signals from a remote user are relayed to the loudspeaker element 22, and speech of the local user is captured by the microphone 26. If no call is accepted, the wireless headset 10 may be in a powered state without a connection in progress. If no communication link with another device has been established, the wireless headset 10 may be in a powered state in which the wireless headset 10 is receptive for pairing requests from other devices.

In an embodiment, the wireless headset 10 is further configured to be capable of establishing a further communication link with a different device (such as another device different from the device 12) when at least one communication link is already active. In an embodiment, the wireless headset 10 is further configured to be capable of accepting a further call when at least one call is already active. As an example, the user may be provided with a possibility of placing a first call on hold while answering a second call.

In an embodiment, the connection attempt is a stream of audio such as music being played by a media player of the mobile device 12. In an embodiment, accepting the connection attempt results in the wireless headset 10 being in an active state in which the audio stream is reproduced using the loudspeaker element 22.

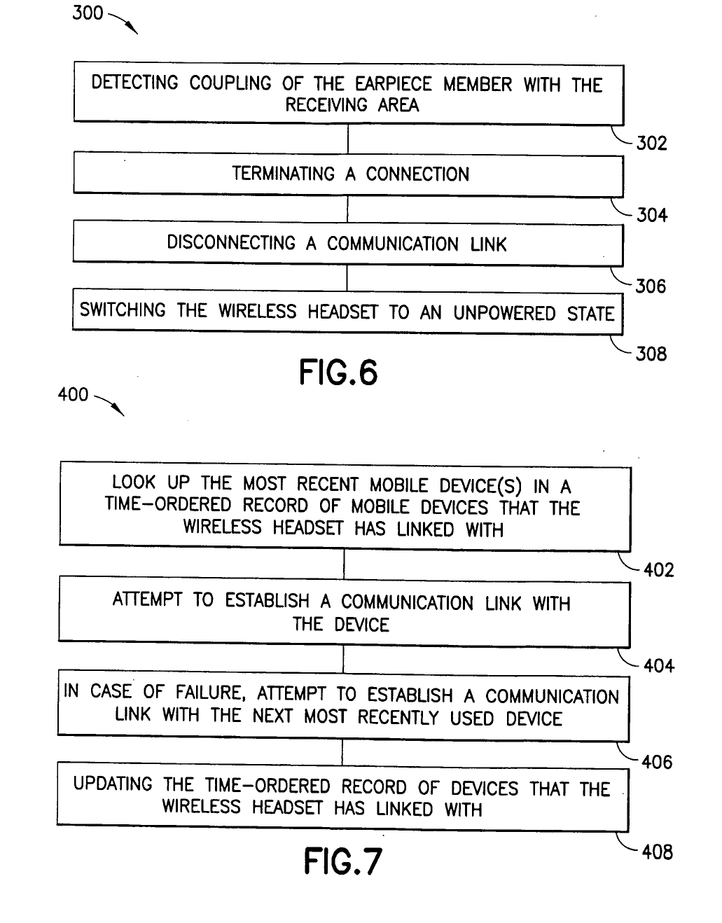

FIG. 6 is a flow diagram illustrating another method 300 according to an example embodiment of the invention. Consider the wireless headset 10 of FIG. 2 in a powered state. In this state, the receiver 42, the transmitter 40, the processor 36, and other elements of the wireless headset 10 may be in an operating state, a communication link may exist with other devices, and the wireless headset 10 may be powered by the battery 44. In an embodiment, the communication link may be a Bluetooth connection. Further, an active connection may be in progress. In an embodiment, the connection is a phone call. In an embodiment, the connection is a stream of audio such as music being played by a media player. The powered state may correspond to the state illustrated in FIG. 2, where the earpiece member 14 is removed from (or uncoupled) from the receiving area 32. At 302, if the earpiece member 14 is then coupled with the receiving area 32, this results in an actuation of the detection switch 48. At 304, this causes a possible active connection to be terminated. In an embodiment, all active connections are terminated. In an embodiment, termination of an active connection may mean terminating an active call, rejecting an incoming call, or cancelling an outgoing call attempt. The communication link between the wireless headset 10 and the mobile device 12 is disconnected at 306. The wireless headset 10 is switched to an unpowered state at 308.

FIG. 7 is a flow diagram illustrating another method 400 according to an example embodiment of the invention. In an embodiment, the wireless headset 10 attempts to establish a communication link with another device, which may be the mobile device 12. This may be carried out using information stored in a list of recently used devices in the memory 38. The list may contain identification information about mobile devices that the wireless headset 10 has recently linked with. In an embodiment, the list is time-ordered, for example, in a reverse order in such a way that the most recently used device is listed first, followed by the second last used, and continuing similarly in reverse temporal order with any further devices. At 402, if the list is non-empty, the wireless headset 10 looks up the most recently used device on the list. At 404, the wireless headset 10 attempts to establish a communication link with the device. At 406, in case of failure, the next most recently used device not yet attempted is looked up from the list and establishing a communication link with it is attempted. This is continued until either a communication link has been successfully established, or the list of devices is exhausted. As a result, the wireless headset 10 is in a powered state in which a communication link with another device may exist. The time-ordered record of devices that the wireless headset 10 has linked with is updated accordingly at 408. In this state, the wireless headset 10 may be receptive for establishing a communication link with a device not found on the list of recently used devices. If a communication link with another device has been successfully established, the wireless headset 10 detects whether an incoming call attempt is being received by the mobile device. If no such call is detected, the wireless headset 10 remains in a powered no call state.

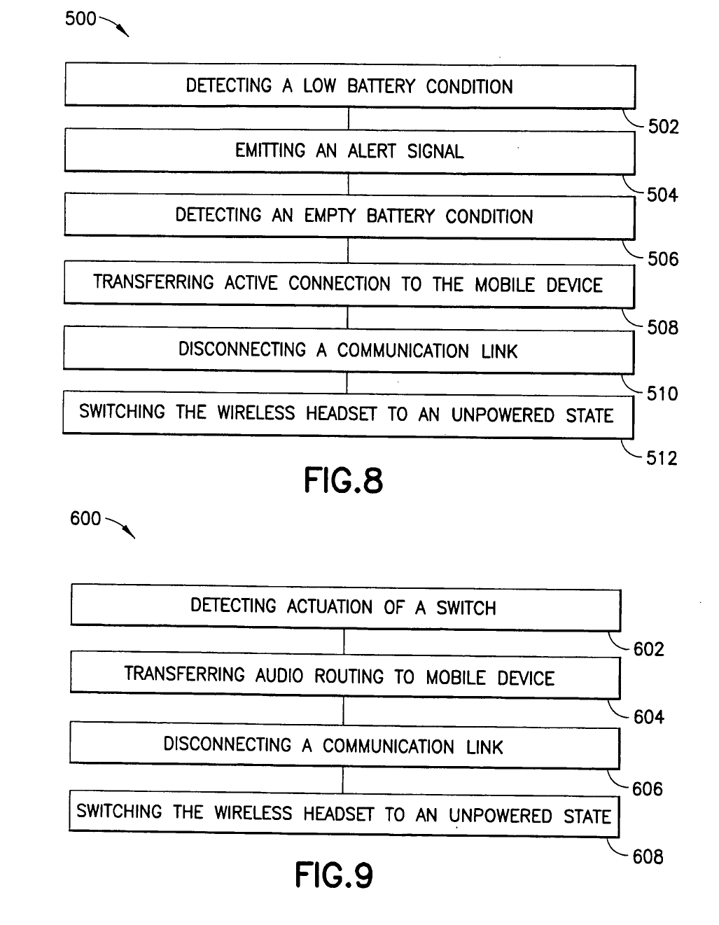

FIG. 8 is a flow diagram illustrating another method 500 according to an example embodiment of the invention. In an embodiment, the wireless headset 10 is configured to monitor the charge level of the battery 44. Monitoring may be done using the voltage monitoring element 50, for example. At 502, it is detected that the charge level of the battery 44 is at or below a first battery charge level, which may correspond to a low charge level. If this is detected, the wireless communication device 10 is considered to be in a low charge state. At 504 the wireless communication device 10 may emit an alert signal to inform the user of a low charge state. In an embodiment, the alert signal may be an audio signal, such as a beep, reproduced using the loudspeaker element 22. However, other types of alert signals, such as haptic or visual signals, and/or combinations of different alert signals, are possible. The alert signal may be given using the alert element 52, for example. The alert signal may be emitted once when the first battery charge level is detected, or repeatedly for as long as the wireless headset 10 remains powered and the battery charge level remains below the first battery charge level. If it is detected that the earpiece member 14 has been coupled with (or placed in) the receiving area 32, a possible active connection is terminated, a communication link with another device is disconnected and the wireless headset 10 is switched to an unpowered state. These operations are carried out independently of whether an alert signal has been previously emitted.

At 506, the charge level of the battery 44 is determined to be at or below a second battery charge level. In an embodiment, a secondary battery charge level corresponds to a substantially empty charge level. At 508 a possible active connection is transferred to be handled by the mobile device 12. In an embodiment, the connection is a phone call. In this embodiment, transfer of the active connection comprises routing audio signals from a remote user to be reproduced using a loudspeaker element in the mobile device, and speech of a local user to be captured by a microphone in the mobile device. In an embodiment, the connection may be a stream of audio such as music being played by a media player. In this embodiment, transfer of the active connection comprises routing audio signals from a media player of the mobile device 12 to be reproduced by the loudspeaker element of the mobile device. If a communication link with the mobile device 12 is active, the communication link is disconnected at 510. At 512, the wireless headset 10 is switched to an unpowered state, even if the earpiece member 14 remains uncoupled from the receiving area 32.

FIG. 9 is a flow diagram illustrating another method 600 according to an example embodiment of the invention. In an embodiment, the wireless headset 10 of FIG. 1 comprises the switch 48. At 602, actuation of the switch 48 in a powered state of the wireless headset 10 is detected. At 604, if a connection is in progress, audio routing is transferred to the mobile device 12. In an embodiment, the connection may be a phone call. In an embodiment, transfer of the active connection comprises routing audio signals from a remote user to be reproduced using a loudspeaker element in the mobile device, and speech of a local user to be captured by a microphone in the mobile device. In an embodiment, the connection is a stream of audio such as music being played by a media player. In an embodiment, transfer of the active connection comprises routing audio signals from a media player of the mobile device 12 to be reproduced by a loudspeaker element of the mobile device 12. A possible communication link with the mobile device 12 is disconnected at 606, and the wireless headset 10 is switched to an unpowered state at 608 even if the earpiece member 14 remains uncoupled from the receiving area 32. After a possible subsequent coupling of the earpiece member 14 into receiving area 32, the wireless headset 10 remains in an unpowered state.

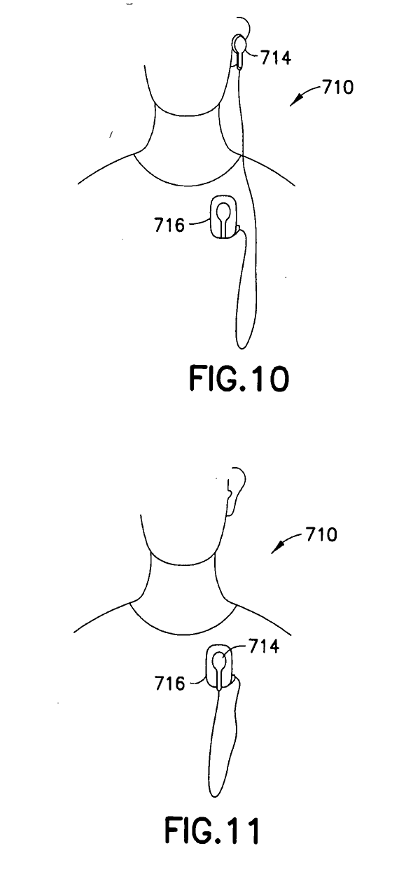

Referring now to FIGS. 10-14, there are shown views of a wireless headset unit device 710 in accordance with another embodiment of the invention. The wireless headset unit device 710 is similar to the wireless headset unit device 10 and similar features are similarly numbered. The wireless headset unit device 710 has an earpiece member 714 and a main body member 716 substantially the same as shown in FIGS. 1-3. However, in this embodiment, one difference is that the main body member 716 comprises a receiving area (or storage slot) 732 at a front side of the main body member (instead of at a top end of the main body member as shown in FIGS. 1-3). Similar to the receiving area 32, the receiving are 732 is configured to securely hold the earpiece member 714 when received in the receiving area 732. Also similar to the headset 10, removing the earpiece 714 from storage slot 732 causes the headset 710 to power up, connect to a paired device (such as the mobile phone 12), and accept a call. Also similar to the headset 10, returning the earpiece 714 to the storage slot 732 causes the headset unit 710 to terminate the connection, disconnect the communication link (to the paired device), and switch the wireless headset 710 to an unpowered state.

According to some embodiments of the invention, an input control member may not be provided. For example, some embodiments of the invention may provide a microphone proximate the earpiece member 714. In some other embodiments, a microphone may be provided proximate the main body member 716. However, it should be noted that according to some embodiments of the invention, the headset unit 710 may further include an input control member between the earpiece member and the main body member (as provided in the headset unit 10).

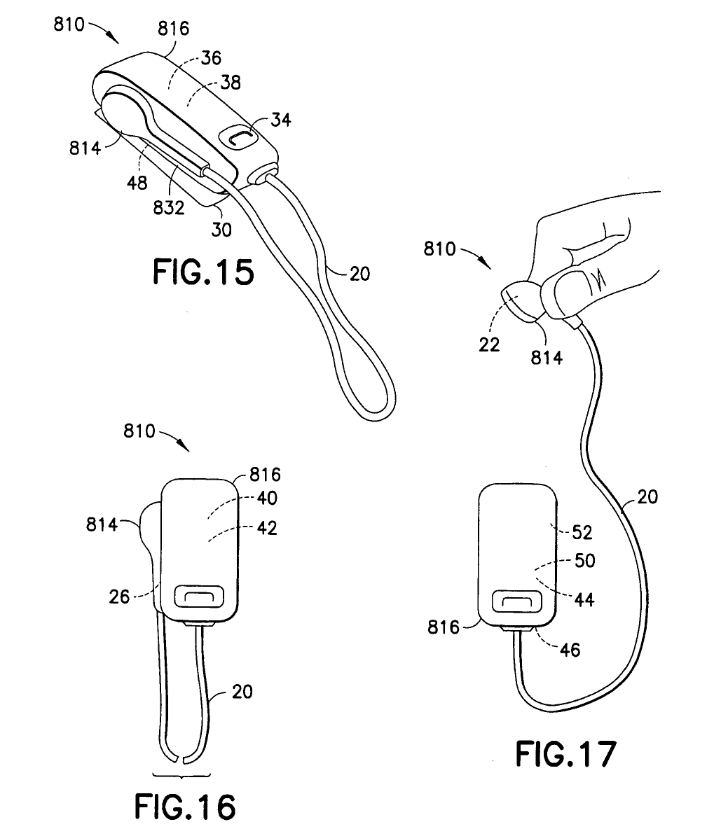

Referring now to FIGS. 15-17, there are shown views of a wireless headset unit device 810 in accordance with another embodiment of the invention. The wireless headset unit device 810 is similar to the wireless headset unit device 10, 710 and similar features are similarly numbered. The wireless headset unit device 810 has an earpiece member 814 and a main body member 816 substantially the same as shown in FIGS. 1-3, 10-14. However, in this embodiment, one difference is that the main body member 816 comprises a receiving area (or storage slot) 832 at a lateral side of the main body member (instead of at a top end of the main body member as shown in FIGS. 1-3, or a front side of the main body member as shown in FIGS. 10-14). Similar to the receiving area 32, 732, the receiving are 832 is configured to securely hold the earpiece member 814 when received in the receiving area 832. Also similar to the headset 10, 710, removing the earpiece 814 from storage slot 832 causes the headset 810 to power up, connect to a paired device (such as the mobile phone 12), and accept a call. Also similar to the headset 10, 710, returning the earpiece 814 to the storage slot 832 causes the headset unit 810 to terminate the connection, disconnect the communication link (to the paired device), and switch the wireless headset 810 to an unpowered state.

According to some embodiments of the invention, an input control member may not be provided. For example, some embodiments of the invention may provide a microphone proximate the earpiece member 814. In some other embodiments, a microphone may be provided proximate the main body member 816. However, it should be noted that according to some embodiments of the invention, the headset unit 810 may further include an input control member between the earpiece member and the main body member (as provided in the headset unit 10).

Without in any way limiting the scope, interpretation, or application of the claims appearing below, a technical effect of one or more of the example embodiments disclosed herein is that removal of the earpiece member from the receiving area causes the wireless headset to undergo a transition from an unpowered state to an active call state, without a need to perform other actuation or configuration actions. Another technical effect of one or more of the example embodiments disclosed herein is that the wireless headset can be activated and connected to a mobile device by removing the earpiece member from the receiving area. Another technical effect of one or more of the example embodiments disclosed herein is that a user can accept an incoming phone call by removing (or uncoupling) the earpiece member from the main body member. Another technical effect of one or more of the example embodiments disclosed herein is that a user can route an audio signal such as music played by a media player in a mobile device to be reproduced by a loudspeaker element in the wireless headset. Another technical effect of one or more of the example embodiments disclosed herein is that placing (or coupling) the earpiece member in the receiving area causes a possible call or reproduction of music by the headset to be terminated, a possible communication link with another device to be disconnected, and the wireless headset to be switched to an unpowered state. Another technical effect of one or more of the example embodiments disclosed herein is that actuation of a switch provided in the wireless headset can be used to transfer audio routing of an active call from the wireless headset to another device. Another technical effect of one or more of the example embodiments disclosed herein is that actuation of a switch provided in the wireless headset can be used to disconnect a communication link with another device and to switch the wireless headset to an unpowered state. Another technical effect of one or more of the example embodiments disclosed herein is that a carrying solution is provided for wireless headsets. Another technical effect of one or more of the example embodiments disclosed herein is that a charging solution is provided.

It should be understood that components of the invention can be operationally coupled or connected and that any number or combination of intervening elements can exist (including no intervening elements). The connections can be direct or indirect and additionally there can merely be a functional relationship between components.

As used in this application, the term ‘circuitry’ refers to all of the following: (a) hardware-only circuit implementations (such as implementations in only analog and/or digital circuitry) and (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions) and (c) to circuits, such as a microprocessor(s) or a portion of a microprocessor(s), that require software or firmware for operation, even if the software or firmware is not physically present.

This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in server, a cellular network device, or other network device.

Embodiments of the present invention may be implemented in software, hardware, application logic or a combination of software, hardware and application logic. The software, application logic and/or hardware may reside on the wireless headset unit device, the mobile device or on a server. If desired, part of the software, application logic and/or hardware may reside on wireless headset unit device, part of the software, application logic and/or hardware may reside on mobile device, and part of the software, application logic and/or hardware may reside on server. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of a computer described and depicted in FIG. 3. A computer-readable medium may comprise a computer-readable storage medium that may be any media or means that can contain or store the instructions for use by or in connection with an instruction execution system, apparatus, or device, such as a computer.

If desired, the different functions discussed herein may be performed in a different order and/or concurrently with each other. Furthermore, if desired, one or more of the above-described functions may be optional or may be combined.

Below are provided further descriptions of various non-limiting, exemplary embodiments. Various aspects of one or more exemplary embodiments may be practiced in conjunction with one or more other aspects or exemplary embodiments. That is, the exemplary embodiments of the invention, such as those described immediately below, may be implemented, practiced or utilized in any combination (for example, any combination that is suitable, practicable and/or feasible) and are not limited only to those combinations described herein and/or included in the appended claims.

In one exemplary embodiment, an apparatus comprising: an earpiece member; and a main body member comprising a receiving area, wherein the main body member is configured to provide a communication link with a mobile device, wherein the receiving area is configured to removably receive the earpiece member, and wherein the apparatus is configured to perform a predetermined operation in response to removal of the earpiece member from the receiving area.

An apparatus as above, wherein the predetermined operation comprises switching the apparatus to a powered state, establishing a communication link with the mobile device, and detecting a connection attempt and accepting the connection attempt when the removal is detected.

An apparatus as above, wherein the apparatus is further configured to detect a coupling of the earpiece member with the receiving area and perform at least one of terminating a connection, disconnecting a communication link, and switching the apparatus to an unpowered state when the coupling is detected.

An apparatus as above, wherein the earpiece member comprises a loudspeaker element.

An apparatus as above, wherein the main body member further comprises a Bluetooth receiver and a Bluetooth transmitter.

An apparatus as above, wherein the earpiece member is a separate member from the main body member.

An apparatus as above, wherein the apparatus comprises a wireless headset.

An apparatus as above, wherein the mobile device comprises a mobile phone.

In another exemplary embodiment, an apparatus comprising: an earpiece member; a main body member comprising a receiving area, wherein the main body member is configured to provide a communication link with a mobile device, wherein the receiving area is configured to removably receive the earpiece member; at least one processor; and at least one memory including computer program code, the at least one memory and the computer program code configured to, with the at least one processor, cause the apparatus to perform at least the following: detect a movement of the earpiece member at the receiving area; and perform a predetermined operation in response to the detected movement of the earpiece member at the receiving area.

An apparatus as above, wherein the predetermined operation comprises switching the apparatus to a powered state and establishing a communication link with the mobile device.

An apparatus as above, wherein the movement of the earpiece member at the receiving area further comprises a removal of the earpiece member from the receiving area.

An apparatus as above, wherein the predetermined operation comprises terminating a communication link with the mobile device and switching the apparatus to an unpowered state.

An apparatus as above, wherein the movement of the earpiece member at the receiving area further comprises a placement of the earpiece member in the receiving area.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

1. An apparatus, comprising:
an earpiece member; and
a main body member comprising a receiving area, wherein the main body member is configured to provide a communication link with a mobile device, wherein the receiving area is configured to removably receive the earpiece member, and wherein the apparatus is configured to perform a predetermined operation in response to removal of the earpiece member from the receiving area.

2. An apparatus as in claim 1 wherein the predetermined operation comprises switching the apparatus to a powered state, establishing a communication link with the mobile device, and detecting a connection attempt and accepting the connection attempt when the removal is detected.

3. An apparatus as in claim 1 wherein the apparatus is further configured to detect a coupling of the earpiece member with the receiving area and perform at least one of terminating a connection, disconnecting a communication link, and switching the apparatus to an unpowered state when the coupling is detected.

4. An apparatus as in claim 1 wherein the earpiece member comprises a loudspeaker element.

5. An apparatus as in claim 1 wherein the main body member further comprises a Bluetooth receiver and a Bluetooth transmitter.

6. An apparatus as in claim 1 wherein the earpiece member is a separate member from the main body member.

7. An apparatus as in claim 1 wherein the apparatus comprises a wireless headset.

8. An apparatus as in claim 1 wherein the mobile device comprises a mobile phone.

9. A method, comprising:
detecting removal of an earpiece member of a wireless headset device from a main body member of the wireless headset device; and
performing a predetermined operation in response to the detected removal of the earpiece member of the wireless headset device from the main body member of the wireless headset device.

10. A method as in claim 9 wherein the predetermined operation comprises switching the wireless headset device to a powered state, establishing a communication link with a mobile device, and detecting a connection attempt and accepting the connection attempt when the removal is detected.

11. A method as in claim 9 wherein the wireless headset device is further configured to detect a coupling of the earpiece member with a receiving area of the main body member and perform at least one of terminating a connection, disconnecting a communication link, and switching the wireless headset device to an unpowered state when the coupling is detected.

12. A method as in claim 9 wherein the earpiece member and the main body members are separate members.

13. A method as in claim 9 wherein the main body member further comprises a receiver and a transmitter.

14. A method as in claim 9 wherein the earpiece member comprises a loudspeaker element.

15. A method as in claim 9 wherein the wireless headset device is configured to provide a Bluetooth wireless link with a mobile phone.

16. An apparatus, comprising:
an earpiece member;
a main body member comprising a receiving area, wherein the main body member is configured to provide a communication link with a mobile device, wherein the receiving area is configured to removably receive the earpiece member;
at least one processor; and
at least one memory including computer program code, the at least one memory and the computer program code configured to, with the at least one processor, cause the apparatus to perform at least the following:
detect a movement of the earpiece member at the receiving area; and
perform a predetermined operation in response to the detected movement of the earpiece member at the receiving area.

17. An apparatus as in claim 16 wherein the predetermined operation comprises switching the apparatus to a powered state and establishing a communication link with the mobile device.

18. An apparatus as in claim 16 wherein the movement of the earpiece member at the receiving area further comprises a removal of the earpiece member from the receiving area.

19. An apparatus as in claim 16 wherein the predetermined operation comprises terminating a communication link with the mobile device and switching the apparatus to an unpowered state.

20. An apparatus as in claim 16 wherein the movement of the earpiece member at the receiving area further comprises a placement of the earpiece member in the receiving area.
